(19) United States
(12) Patent Application Publication
(10) Pub. No.: US 2007/0225976 A1
(43) Pub. Date: Sep. 27, 2007

(54) Method of producing speech files

(76) Inventor: Hong-Yung Wang, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/384,451

(22) Filed: Mar. 21, 2006

(51) Int. Cl. G10L 15/26

(52) U.S. Cl. 704/235

(57) ABSTRACT

A method for method for producing audible speech files has the steps of transmitting a phonebook in a cell phone to a supported speech-playing device, converting the phonebook to text format data, uploading the text format data to a server, producing speech files based on the text format data with the server, transmitting the speech files to the speech-playing device, and broadcasting one of the speech files when an incoming call is detected.

### BACKGROUND OF THE INVENTION

1. Field of the Invention

The present invention relates to a method of producing audible speech files, and more particularly to a method that uses a server to produce speech files based on a phonebook stored in a cell phone, wherein the speech files can be played when an incoming call is detected.

2. Description of Related Art

As mobile phones popularize, the phones provide users with more beneficial services. The function of playing speech file generally needs a separate high efficiency digital signal processor (DSP) to perform complex and large calculations for converting text data to audio data. Therefore, the cell phone integrand with the DSP needs high fabricating cost and is uncommon. However, most cell phones are capable of playing speech files.

For instance, a user can record different sounds in the cell phones as speech files. Therefore, the name of a caller would be recognizable according to the speech file automatically played by the mobile phone when an incoming call is received without checking the cell phone. In addition to the user-recorded speech files, audio files pre-stored in the cell phone also can be used as the speech files, but a high capacity memory for storing the audio files is required.

To overcome the shortcomings, the present invention provides a method of producing speech files applicable for a speech-playing device to mitigate or obviate the aforementioned problems.

### SUMMARY OF THE INVENTION

The main objective of the invention is to provide a method of producing audible speech files, wherein a remote sever is used to convert a phonebook in a cell phone to speech files that can be broadcast by either a speech-playing device or the cell phone when an incoming call is detected.

According to the method, a phonebook in a cell phone is firstly transmitted to a speech-playing device. The speech-playing device converts the phonebook to text format data and uploads the text format data to a server. Upon receipt of the text format data, the server produces speech files and then transmits the speech files to the speech-playing device. When an incoming call is detected by the speech-playing device, one of the speech files is selected and broadcast.

Other objectives, advantages and novel features of the invention will become more apparent from the following detailed description when taken in conjunction with the accompanying drawings.

### BRIEF DESCRIPTION OF THE DRAWINGS

FIG. 1 shows a system of producing speech files in accordance with a method of a first embodiment of the present invention;

FIG. 2 shows an operating sequence performed by the system of FIG. 1;

FIG. 3 is a block diagram of a speech-playing device in FIG. 1;

FIG. 4 shows a system of producing speech files in accordance with the method of a second embodiment of the present invention;

FIG. 5 shows an operating sequence practiced by the system of FIG. 4;

FIG. 6 shows a system of producing speech files in accordance with the method of a third embodiment of the present invention;

FIG. 7 shows an operating sequence practiced by the system of FIG. 6;

FIG. 8 shows a system of producing speech files in accordance with the method of a fourth embodiment of the present invention; and

FIG. 9 shows an operating sequence practiced by the system of FIG. 8.

### DETAILED DESCRIPTION OF PREFERRED EMBODIMENT

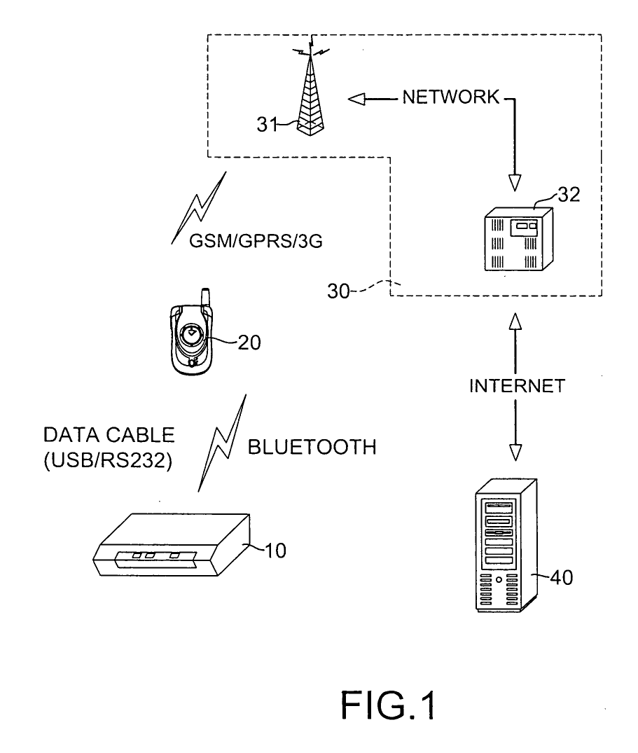

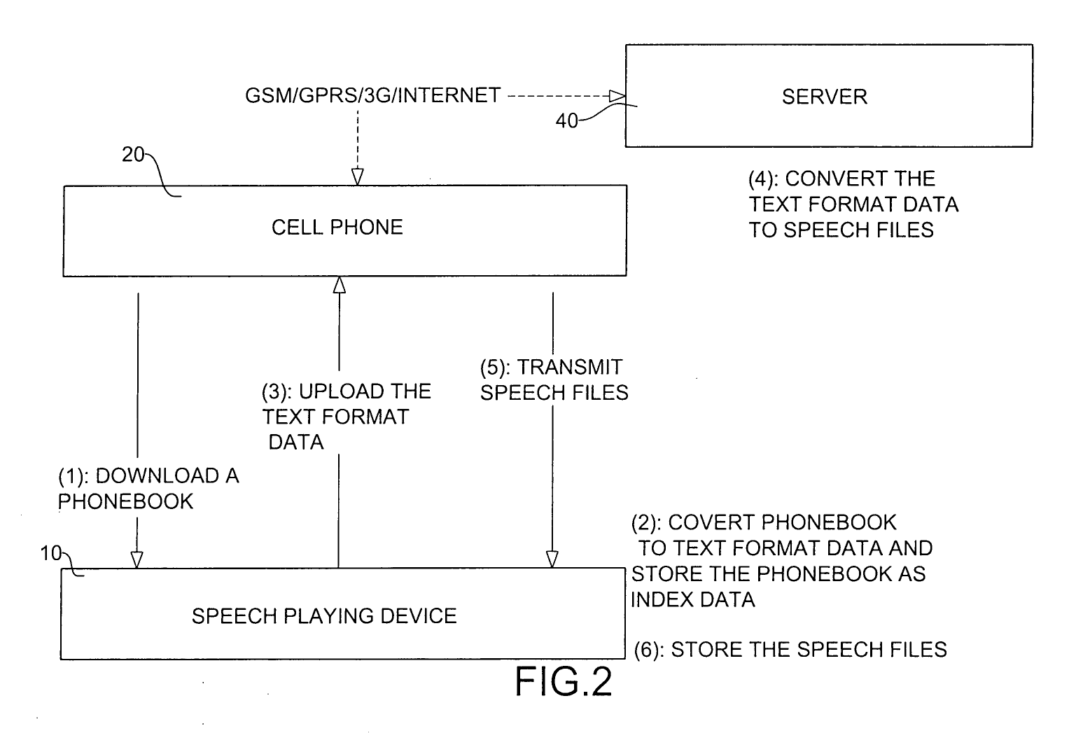

With reference to FIGS. 1 and 2, a method for producing speech files in accordance with the present invention can be practiced by a system that comprises an optional speech-playing device (10), a cell phone (20), a communication system (30) and a text to speech converting server (40).

The cell phone (20) can be any normal cell phone and a phonebook is stored in the cell phone (20). The phonebook may include names of multiple recipients, phone numbers or other information.

The communication system (30) can be a wireless communication system, an Internet network or other devices that can connect to the server (40).

The speech-playing device (10) downloads the phonebook from the cell phone (20) through wireless or wired communication techniques. The phonebook is stored in the device (10) as index data and is converted to text format data. The text data can be a format of ASCII, Big-5, UTF-8 and etc.

After the text format data are created, the speech-playing device (10) transmits the text format data to the server (40) through the cell phone (20). Data transmission between the cell phone (20) and the server (40) may be accomplished by a wireless commutation system (30) such as GSM (global system for mobile communications) or GPRS (general packet radio service) involving multiple cellular base stations (31) and a data exchange (32) to transmit data.

The server (40) converts the text format data to multiple speech files and subsequently returns the speech files to the speech-playing device (10) through the communication system and the cell phone (20). Each recipient in the phonebook can be designated with a respective speech file. Preferably, the name of the recipient is broadcast when the device (10) plays the speech file. Therefore, when an incoming call is detected, the speech-playing device (10) determines whether or not the phone number of the incoming call is recognizable by comparing the phone number with the index data, i.e. the phonebook. If the phone number is recognizable, the device (10) looks up a speech file that corresponds to the caller and broadcasts the speech file.

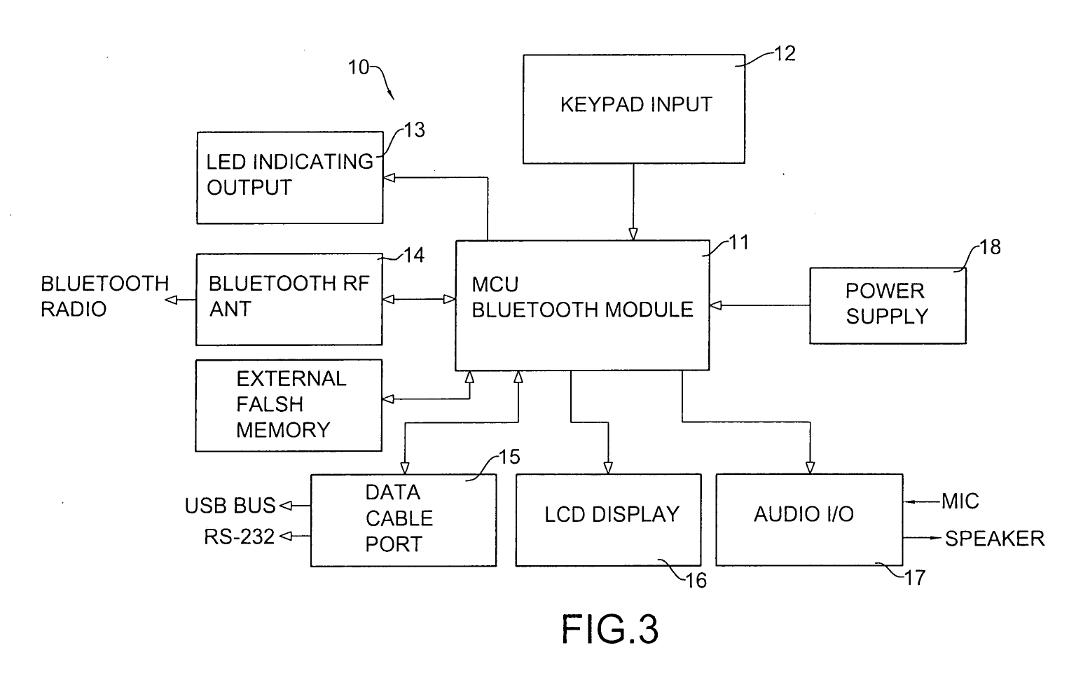

With reference to FIG. 3, a bluetooth-supported speech-playing device (10) is used as an example. However, other wireless communicating techniques are also feasible to transmit data. The speech-playing device (10) comprise a micro control unit (MCU) (11) with a bluetooth module. The MCU (11) connects to a keypad input circuit (12) receiving operating commands, an LED indicating unit (13) showing operating statuses of the device, a bluetooth RF antenna (14), a data cable port (15), an LCD display (16) to display operating information of the device (10), an audio I/O unit (17) and a power supply circuit (18).

The bluetooth RF antenna (14) communicates with any bluetooth-supported device like the cell phone (20). The data cable port (15) can be a USB port or an RS-232 port to connect to a computer. The audio I/O unit (17) can receive sound signals from an external device, such as a microphone, and output speech files to be broadcast to a speaker. The power supply unit (18) converts an external DC voltage to an operating voltage that is applied to the MCU (11).

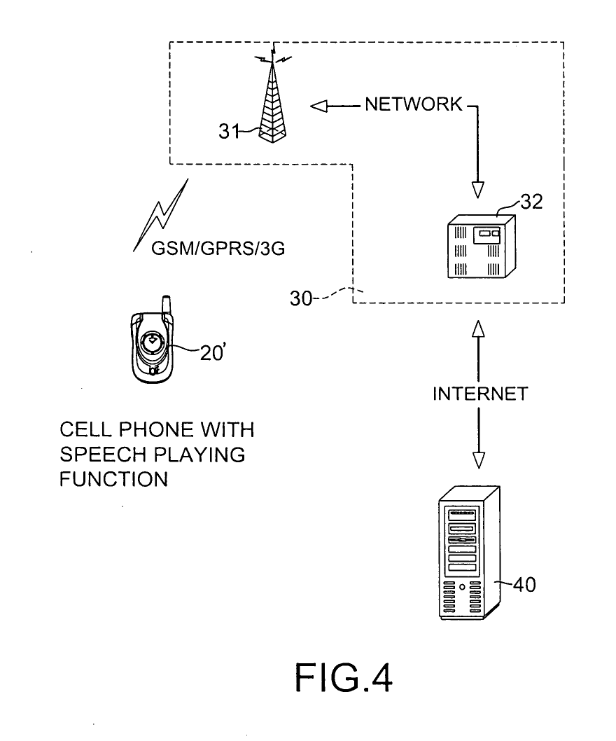

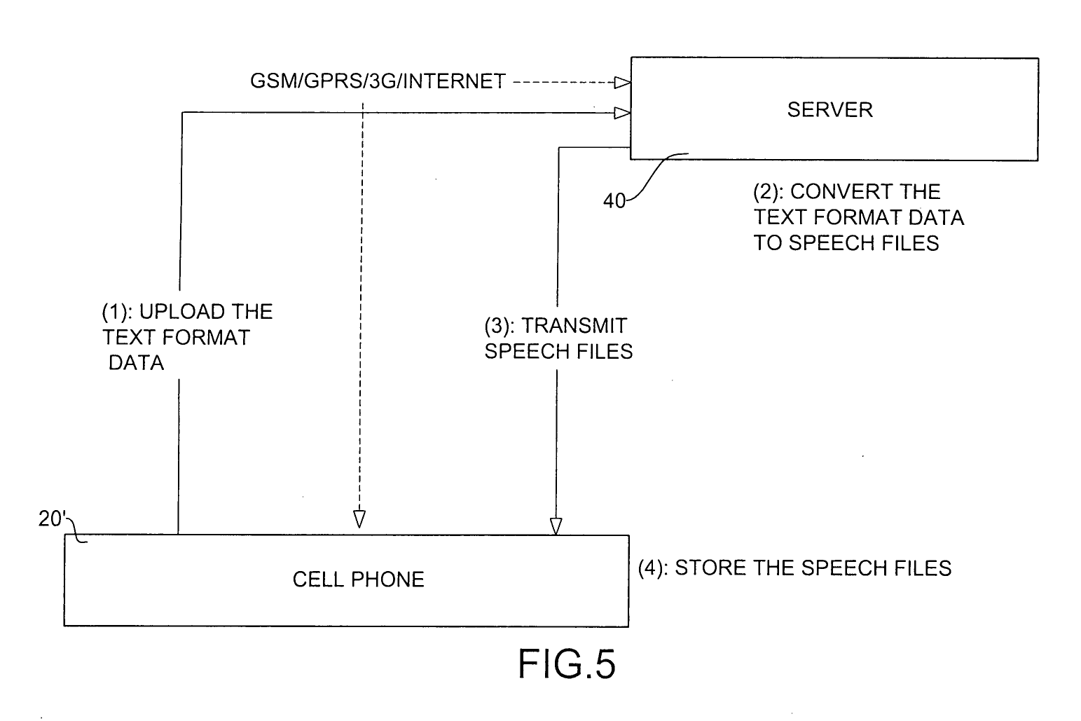

With reference to FIGS. 4 and 5, the system is similar to that of FIG. 1 but the speech-playing device (10) is integrated to the cell phone (20′). The cell phone (20′) directly uploads the text format data to the server (40). The server (40) converts the text format data to multiple speech files and returns the speech files to the cell phone (20′). When an incoming call is received, the cell phone (20′) recognizes the caller based on the stored phonebook and looks up a speech file corresponding to the caller.

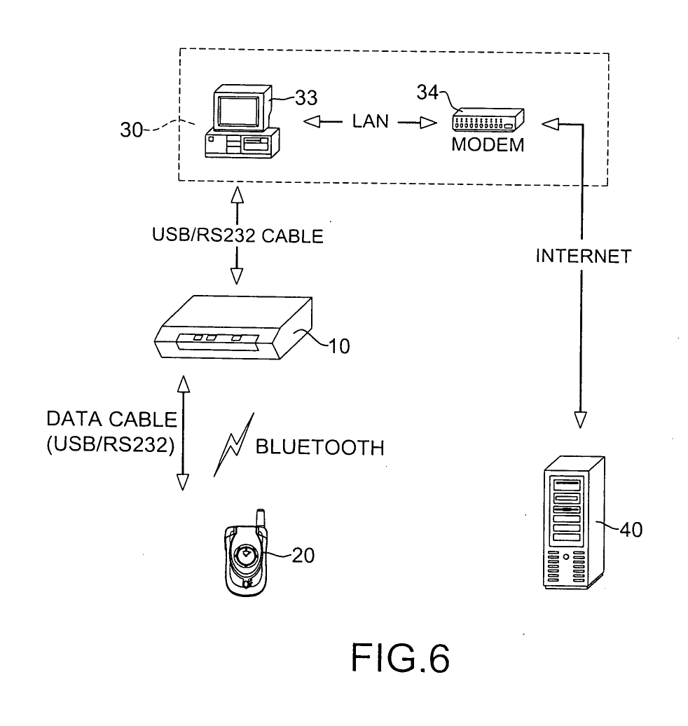

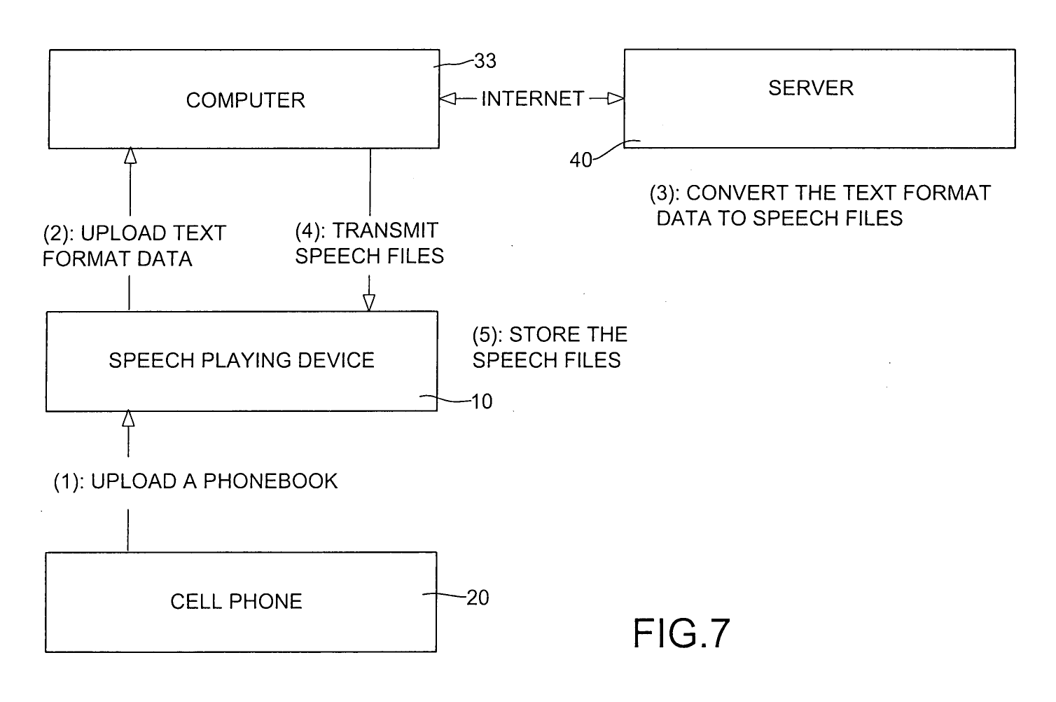

With reference to FIGS. 6 and 7, the system is similar to FIG. 1. The speech-playing device (10) downloads the phonebook from the cell phone (20) through a wireless or wired communication and converts the phonebook to text format data. In stead of using the cell phone (20), the speech-playing device (10) transmits the text format data to the server (40) through an Internet network (30) that may include a computer (33) and a modem (34). The computer (33) is connected to the USB port or the RS232 port of the device (10) to receive the text format data. The text format data is further transmitted to the server (40) for text to speech format converting through the modem (34).

The server (40) based on the text format data produces multiple speech files and subsequently returns the speech files to the speech-playing device (10) through the Internet network (30). Each recipient on the phonebook has a corresponding speech file. Therefore, when an incoming call is detected, the speech-playing device (10) recognizes the caller based on the stored phonebook and looks up a speech file corresponding to the caller.

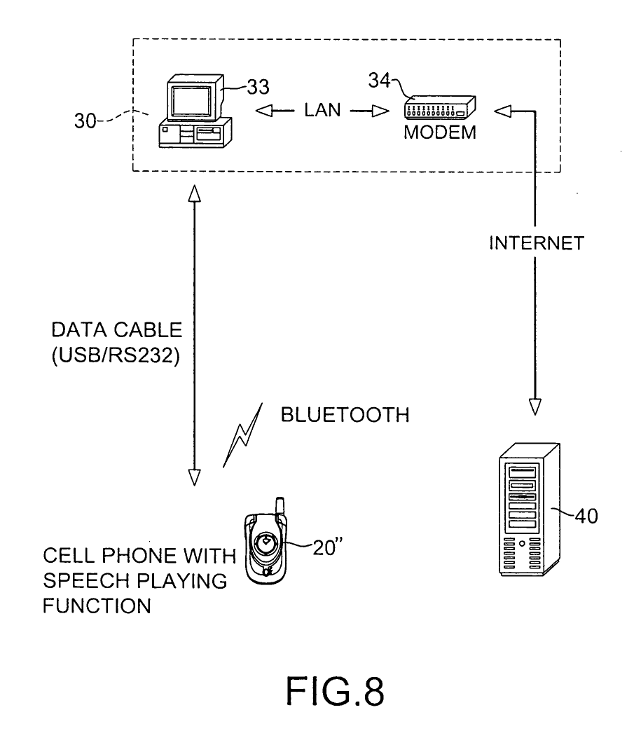

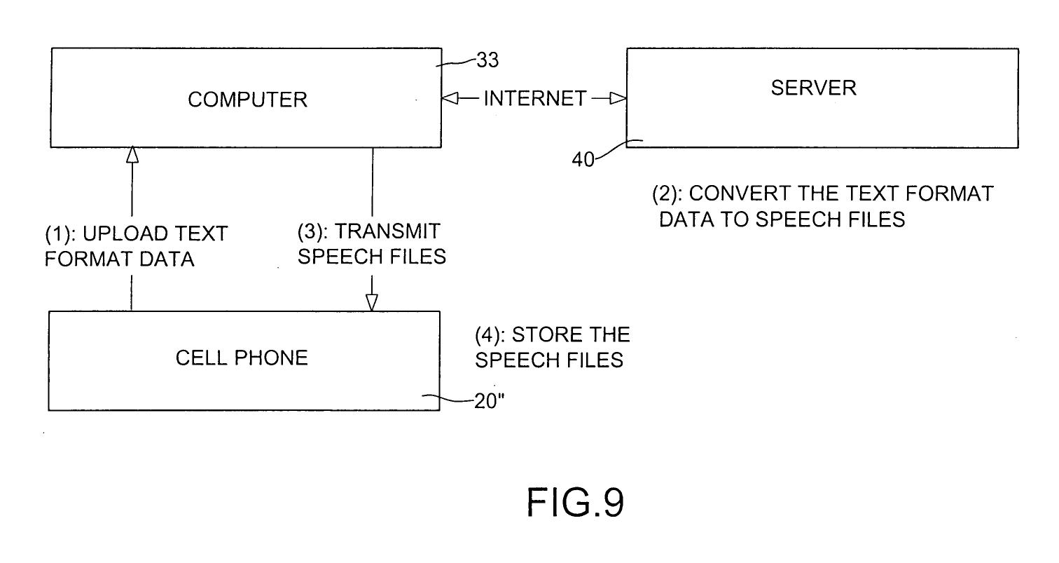

With reference to FIGS. 8 and 9, the system is similar to that of FIG. 6 but the speech-playing device (10) is integrated to the cell phone (20″). The cell phone (20″) directly uploads the text format data to the server (40). The server (40) converts the text format data to multiple speech files and returns the speech files to the cell phone (20″). When an incoming call is detected, the cell phone (20″) recognizes the caller based on the phonebook and looks up a speech file corresponding to the caller. The speech file can be broadcast by the cell phone (20″).

In stead of recording sound files one by one, speech files corresponding to all recipients in the phonebook can be completely produced by the server. The server has the ability to recognize the language of the phonebook in the cell phone to produce the speech files of the same language. Further, an application software can be designed and stored in the computer allowing the user to easily edit or manage the phonebook. The speech files for the cell phone can be played either by the speech-playing device or the cell phone to notify the user that who dials the call. Even though the user does not have a computer, the speech files in the playing device can be timely updated using the cell phone as a data relay device.

The latest version of the operating software for the speech-playing device can be stored in the server. When the speech-playing device links to the server, the original operating software can be automatically updated.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for producing speech files comprising steps of:
transmitting a phonebook in a cell phone to a speech-playing device;
converting the phonebook to text format data;
uploading the text format data to a server;
producing speech files based on the text format data by the server;
transmitting the speech files to the speech-playing device; and
broadcasting one of the speech files when an incoming call is detected by the speech-playing device.

2. The method, as claimed in claim 1, the step of one speech file broadcasting further comprising:
determining whether or not the caller is recognizable by looking up the phonebook in the speech-playing device; and
broadcasting the speech file corresponding to the caller.

3. The method as claimed in claim 1, the step of text format data uploading further comprising:
transmitting the text format data from the speech-playing device to the cell phone; and
transmitting the text format data from the cell phone to the server through a wireless communication system that comprises cellular base stations and a data exchange.

4. The method as claimed in claim 2, the step of text format data uploading further comprising:
transmitting the text format data from the speech-playing device to the cell phone; and
transmitting the text format data from the cell phone to the server through a wireless communication system that comprises cellular base stations and a data exchange.

5. The method as claimed in claim 1, the step of text format data uploading further comprising:
transmitting the text format data from the speech-playing device to the server through Internet.

6. The method as claimed in claim 2, the step of text format data uploading further comprising:
transmitting the text format data from the speech-playing device to the server through Internet.

7. The method as claimed in claim 1, wherein the step of the speech file broadcasting is to broadcast a name of the caller.

8. A method for producing speech files comprising steps of:
converting a phonebook in a cell phone to text format data;
transmitting the text format data to a server;
producing speech files based on the text format data by the server;
transmitting the speech files to the cell phone; and
broadcasting one of the speech files when an incoming call is detected by the cell phone.

9. The method as claimed in claim 8, the step of one speech file broadcasting further comprising:
determining whether or not the caller is recognizable by looking up the phonebook; and
broadcasting the speech file corresponding to the caller.

10. The method as claimed in claim 8, the step of text format data transmitting further comprising:
transmitting the text format data from the cell phone to the server through a wireless communication system that comprises cellular base stations and a data exchange.

11. The method as claimed in claim 9, the step of text format data transmitting further comprising:
transmitting the text format data from the cell phone to the server through a wireless communication system that comprises cellular base stations and a data exchange.

12. The method as claimed in claim 8, the step of text format data transmitting further comprising:
transmitting the text format data from the cell phone to the server through Internet.

13. The method as claimed in claim 9, the step of text format data transmitting further comprising:
transmitting the text format data from the cell phone to the server through Internet.

14. The method as claimed in claim 8, wherein the step of the speech file broadcasting is to broadcast a name of the caller.
